(19) United States
(12) Patent Application Publication
(10) Pub. No.: US 2024/0239938 A1
(43) Pub. Date: Jul. 18, 2024

(54) (METH)ACRYLATE BASED REACTIVE DILUENT COMPOSITIONS FOR UNSATURATED POLYESTER RESINS

(71) Applicant: Evonik Operation GmbH, Essen (DE)

(72) Inventors: Sabine KÖMMELT, Darmstadt (DE); Sebastian Bestgen, Wuerzburg (DE); Margarita Stein, Sulzbach (DE); Doris Saal, Bensheim (DE); Elisabeth Clamer, Darmstadt (DE); Hiral Shah, Frankfurt am Main (DE)

(73) Assignee: Evonik Operation GmbH, Essen (DE)

(21) Appl. No.: 18/559,776

(22) PCT Filed: Apr. 28, 2022
(86) PCT No.: PCT/EP2022/061293

§ 371 Date: Nov. 8, 2023

(30) Foreign Application Priority Data
May 10, 2021 (EP) 21172951.2

(51) Int. Cl. C08F 265/06; C08F 4/10; C08F 4/34; C08F 4/70

(52) U.S. Cl. CPC C08F 265/06; C08F 4/10; C08F 4/34; C08F 4/7096

(57) ABSTRACT

(Meth)acrylate-based reactive diluent compositions can be used for enabling styrene-free curing of unsaturated polyester resins. The reactive diluent compositions have a (meth)acrylic acid ester monomer and a compatibilizing agent including at least one (meth)acrylate moiety and at least one additional ethylenically unsaturated moiety.

### BACKGROUND OF THE INVENTION

Unsaturated polyester (UP) resins are unsaturated synthetic resins formed by the reaction of dibasic organic acids and polyhydric alcohols. Unsaturated polyester resins are widely used in different applications. e.g. coatings, adhesives, relining, gel coats or composites. In composites including sheet molding compounds (SMC) and bulk molding compounds (BMC), UP resins are reinforced with solid materials such as fiberglass, resulting in fiber-reinforced plastic (FRP). UP resins with a high filler content are used for putties, polymer concrete, chemical anchoring, coloring pastes or artificial marble.

UP resins can be cured using reactive diluents, i.e. solvents with crosslinking/curing reactivities, such as styrene. Typically, UP resins are cured with a high styrene content—usually up to 50 wt %. Hence, most UP resins consist of a solution of an unsaturated polyester in styrene. For regulatory, health and safety reasons, many companies aim at reducing the amount of the organ damaging and likely reprotoxic styrene in their resins and thus at developing styrene reduced or even styrene-free systems. For replacing styrene, structural analogues of styrene are often used, which is just a makeshift solution to avoid direct use of styrene. Examples of such workaround solutions are 4-methylstyrene, 4-tert-butyl styrene or 2,4,6-trimethylstyrene.

Despite its adverse physiological properties, styrene is continuously used in UP resins because it is very cheap, has a high dilution power and easily copolymerizes with the unsaturated parts of the polyester resin.

(Meth)acrylic acid and its esters (i.e. (meth)acrylates), are less hazardous and safer to handle compared to styrene, so it would be particularly desirable to use (meth)acrylates as reactive diluents, or in reactive diluent compositions, respectively. Methacrylates are described as reactive diluents for vinyl ester resins. Vinyl ester resins are epoxy resins functionalized with (meth)acrylate end group by the reaction with (meth)acrylic acid or hydroxy (meth) acrylate. These end groups easily crosslink in the final curing step with methacrylates as reactive diluents. However, (meth)acrylates do not simply copolymerize/crosslink with UP resins and can therefore not be used as reactive diluent in such resins.

In accordance with the above, it was an objective of the present invention to provide a new, (meth)acrylate based and styrene-free reactive diluent composition for UP resins. Ideally, such a (meth)acrylate-based reactive diluent composition includes (meth)acrylates with a low vapor pressure, leading even to VOC-free or VOC-reduced reactive diluent compositions (VOC=volatile organic compounds).

### STATE OF THE ART

CN 111978477 A relates to the field of composite materials, in particular to a sheet molding compound raw material, a sheet molding compound product, and a preparation method and application thereof. The sheet molding compound comprises an unsaturated polyester resin, a low shrinkage agent, an initiator, a diluent monomer, a compound containing sulfhydryl, a glass microsphere, a flame retardant, and a reinforcement.

It does not describe the reactive diluent composition according to the present invention. It does likewise not describe a curable resin composition comprising this reactive diluent composition or a pre-accelerated formulation comprising the curable resin composition, nor does it disclose a method of curing unsaturated polyester resins by providing a curable resin composition that comprises the reactive diluent composition of the instant patent application.

WO 2013/124273 relates to a thermosetting, radically curable resin composition containing methacrylate containing resin being suitable for (re)lining.

The resin composition comprises:
(a) 30-70 wt. % of methacrylate containing resin,
(b) 2.5-20 wt. % of unsaturated polyester resin comprising fumaric acid building blocks as unsaturated dicarboxylic acid building blocks and alkoxylated bisphenol A and/or alkoxylated bisphenol F building blocks as diol building blocks,
(c) 1-40 wt. % of ethylenically unsaturated compound, not being benzyl methacrylate, able to copolymerize with (a), (b) and (d); and
(d) 5-80 wt. % of benzyl methacrylate—(see claim 1 and pag1 1, line 26 to page 2, line 3).

It does not describe the reactive diluent composition according to the present invention. It does likewise not describe a curable resin composition comprising this reactive diluent composition or a pre-accelerated formulation comprising the curable resin composition, nor does it disclose a method of curing unsaturated polyester resins by providing a curable resin composition that comprises the reactive diluent composition of the instant patent application.

JP 2003-206306 relates to methyl methacrylate-containing molding materials. The molding material comprises a resin (A) comprising a vinyl monomer (a), a vinyl monomer (b) and a polymer (c), a filler (B) and a curing agent (C).

It does not describe the reactive diluent composition according to the present invention. It does likewise not describe a curable resin composition comprising this reactive diluent composition or a pre-accelerated formulation comprising the curable resin composition, nor does it disclose a method of curing unsaturated polyester resins by providing a curable resin composition that comprises the reactive diluent composition of the instant patent application.

### SUMMARY OF THE INVENTION

In a first aspect, the present invention provides a reactive diluent composition comprising or consisting of a (meth)acrylic acid ester monomer and a compatibilizer; wherein the compatibilizer comprises at least one (meth)acrylate moiety and at least one additional ethylenically unsaturated moiety.

In a second aspect, the invention relates to a curable resin composition comprising at least an unsaturated polyester resin (UPR) and the reactive diluent composition described above.

In a third aspect, the present invention pertains to a pre-accelerated formulation comprising the curable resin composition described above, and at least one accelerator.

In a fourth aspect, the invention provides a styrene-free method of curing unsaturated polyester resins, the method comprising
(a) providing a curable resin composition, or, alternatively, the pre-accelerated formulation as described above,
(b) optionally adding at least one organic or inorganic additive as described above, and
(c) initiating the curing process by adding an initiator.

### DETAILED DESCRIPTION OF THE INVENTION

The inventors have developed a (meth)acrylate-based reactive diluent composition that enables styrene-free curing of UP resins.

More specifically, the inventors have found that UP resins copolymerize with (meth)acrylates upon addition of a compatibilizer, i.e. a multifunctional, preferably difunctional molecule comprising at least one (meth)acrylate moiety and at least one additional ethylenically unsaturated moiety. Said at least one additional ethylenically unsaturated moiety may be, e.g. vinyl, allyl or alkenyl.

Accordingly, the present invention provides a reactive diluent composition comprising or consisting of a (meth)acrylic acid ester monomer and a compatibilizer; wherein the compatibilizer comprises at least one (meth)acrylate moiety and at least one additional ethylenically unsaturated moiety. The (meth)acrylic acid ester monomer and the compatibilizer are different chemical compounds.

Within the context of the present invention, the term “(meth)acrylate” refers to esters of methacrylic acid or of acrylic acid.

In the compatibilizer, the at least one (meth)acrylate moiety and at least one additional ethylenically unsaturated moiety may be connected by a linker moiety comprising a linear, cyclic or branched alkyl or (alky)aryl group having a chain length of C₁ to C₂₀, said linker moiety optionally comprising one or more heteroatom(s), such as O, N or S.

The compatibilizer may be selected from the group consisting of vinylether (meth)acrylates, allylether (meth) acrylates and alkenyl (meth)acrylates. Vinylether (meth)acrylates include e.g. monovinylether mono(meth)acrylates, monovinylether di(meth)acrylates, monovinylether tri(meth)acrylates, monovinylethertetra(meth)acrylates; divinylether mono(meth)acrylates, divinylether di(meth)acrylates, divinylether tri(meth)acrylates; and trivinylether mono(meth)acrylates, trivinylether di(meth)acrylates. Allylether (meth)acrylates include e.g. including monoallylether mono(meth)acrylates, monoallylether di(meth)acrylates, monoallylether ti(meth)acrylates, monoallylether tetra(meth)acrylates; diallylether mono(meth)acrylates, diallylether di(meth)acrylates, diallylether tri(meth)acrylates; and triallylether mono(meth)acrylates, triallylether di(meth)acrylates. Alkenyl (meth)acrylates include mono, di, tri and tetra(meth)acrylates containing one or more ethylenically unsaturated alkenyl (C═C) moiety being different from (meth)acrylate.

Advantageously, the compatibilizer is selected from the group consisting of 4-(vinyloxy)butyl methacrylate, 2-(allyloxy)ethyl methacrylate, isoprenol methacrylate, 2,2-bis((allyloxy)methy)butyl methacrylate, 2-((allyloxy)methyl)-2-ethylpropane-1,3-diyl bis(2-methylacrylate), and eugenol methacrylate; 4-(vinyloxy)butyl methacrylate, 2-(allyloxy)ethyl methacrylate and isoprenol methacrylate are particularly preferred, as they show good resin compatibility and curing properties.

The (meth)acrylic acid ester monomer may be selected from alkyl (meth)acrylates with linear or branched alkyl C1-20, (alkyl) aryl (meth)acrylates, hydroxy alkyl (meth)acrylate, (poly) ether methacrylates, di, tri, tetra-methacrylates, and mixtures thereof.

Examples for suitable (meth)acrylic acid ester monomers are methyl (meth)acrylate, isobornyl (meth)acrylat, norbomyl (meth)acrylate, tert-butyl (meth)acrylat, ethyl (meth)acrylat, propyl (meth)acrylate, i-propyl (meth)acrylate), n-butyl (meth)acrylat, i-butyl (meth)acrylat, cyclohexyl (meth)acrylat, iso-hexyl (meth)acrylat, n-hexyl (meth)acrylate, 2-ethylhexyl (metha)crylate, 2-propylheptyl (meth)acrylate), iso-decyl (meth)acrylate, iso-tridecyl (meth)acrylate, benzyl (meth)acrylate, isobornyl (meth)acrylate, 3,3,5-trimethyl cyclohexyl methacrylate, norbomyl (meth)acrylate, dihydrodicyclopentadienyl (meth)acrylate, lauryl (met)acrylate, stearyl (meth)acrylate, behenyl (meth)acrylate, hydroxyethyl (meth)acrylat, hydroxypropyl (meth)acrylat, hydroxybutyl (meth)acrylate, hydroxyethylphosphate (meth)acrylate, tetrahydrofurfuryl (meth)acrylat, ethyltriglycol (meth)acrylate, butyldiglycol (meth)acrylate, glycidyl (meth)acrylate, glycerol formal (meth)acrylate, isopropylidenglycerine (meth)acrylate, isosorbide mono-(meth)acrylate, isosorbide di(meth)acrylate, 3(4),8(9)-dimethacryloyloxymethyl-ticyclo[5.2.1.0⁽²⁻⁶⁾]decan (dimethacrylate of 3,8-dihydroxymethyl-trcyclo[5.2.1.0^{2,6}-]decane), allyl (meth)acrylate, ethylene glycol di(meth)acrylate, triethylene glycol di(meth)acrylate, polyethylene glycol 200 di(meth)acrylate, 1,3-butanediol di(meth)acrylate, 1,4-butanediol di(meth)acrylate, 2,3-butanediol di(meth)acrylate, 1,6-hexanediol di(meth)acrylate and its isomers, glycerol di(meth)acrylate, trimethylolpropane di(meth)acrylate, neopentyl glycol di(meth)acrylate, dipropylene glycol di(meth)acrylate, tripropylene glycol di(meth)acrylate, PPG250 di(meth)acrylate, tricyclodecane dimethylol di(meth)acrylate, 1,10-decanediol di(meth)acrylate, tetraethylene glycol di(meth)acrylate, trimethylolpropane tri(meth)acrylate, glycidyl (meth)acrylate, and mixtures thereof.

Advantageously, the (meth)acrylic acid ester monomer is selected from methyl methacrylate, glycerol formal methacrylate, benzyl methacrylate, cyclohexyl methacrylate, isobornyl methacrylate,1,4-butanediol dimethacrylate, polyethyleneglycol 200 dimethacrylate, ethylene glycol dimethacrylate, butyl diglycol methacrylate and ethyltriglycol methacrylate.

It is noted that methacrylate monomers as reactive diluents with a low vapor pressure are of advantage to formulate low or even no VOC resin compositions. The use of styrene in composite resins results in the emission of styrene vapor into the working atmosphere. This exposes the workers and the environment to hazardous vapor. Methyl methacrylate compared to styrene is a less hazardous compound, but it is also classified as VOC due to its high vapor pressure. Therefore, the use of methacrylate monomers like benzyl methacrylate, glycerol formal methacrylate or 1,4-butanediol dimethacrylate with a higher molecular weight and therefore also a lower vapor pressure is preferred to reduce the VOC content.

In a particularly preferred embodiment of the present invention, the (meth)acrylic acid ester monomer is benzyl methacrylate and the compatibilizer is 4-(vinyloxy)butyl methacrylate, 2-(allyloxy)ethyl methacrylate or isoprenol methacrylate.

The present invention is further directed to a reactive diluent composition comprising:
(a) 50 wt. % to 99 wt. % of a (meth)acrylic acid ester monomer or a mixture of different (meth)acrylic acid ester monomers;
(b) 1 wt. % to 50 wt. % of a compatibilizer, wherein the compatibilizer comprises at least one (meth)acrylate moiety and at least one additional ethylenically unsaturated moiety; and
(c) 0 wt. % to 0.5 wt. % of a polymerization inhibitor.

The content of each component (a), (b) and (c) is based on the total amount of the reactive diluent composition. In a particular embodiment, the proportions of (a), (b) and (c) add up to 100 wt. %.

The (meth)acrylic acid ester monomer and the compatibilizer have the meanings as defined further above.

The ratio of the amount of (meth)acrylic acid ester monomer to the amount of compatibilizer is between 1:1 and 70:1 or between 3:1 and 40:1 or between 10:1 and 25:1 and preferably is 20:1.

In order to prevent undesirable polymerization, polymerization inhibitors (stabilizers) can be used in the reactive diluent composition according to the present invention. Within the context of the present invention, the terms “(polymerization) inhibitor” and “stabilizer” are used synonymously. Advantageously, the polymerization inhibitor is selected from the group consisting of hydroquinones, hydroquinone ethers such as hydroquinone monomethyl ether or di-tert-butylcatechol, phenothiazine, N,N′-(diphenyi-p-phenylenediamine, 4-hydroxy-2,2,6-tetramethylpiperidin-1-oxyl, p-phenylenediamine, methylene blue or sterically hindered phenols. Preferably, the polymerization inhibitor is selected from hydroquinone monomethyl ether, phenothiazine, 2,4-dimethyl-8-tert-butylphenol, 2,6-di-tert-butyl-4-methyl-phenol, octadecyl-3-(3,5-di-tert-butyl-4-hydroxyphenyl)-propionate (such as IRGANOX 1076) and 4-hydroxy-2,2,6,6-tetramethylpiperidin-1-oxyl, and mixtures thereof.

Further, the present invention pertains to a curable resin composition comprising at least an unsaturated polyester resin and the reactive diluent composition described above.

In a preferred embodiment, the curable resin composition comprises:
(a) 30 wt. % to 65 wt. % of an unsaturated polyester resin;
(b) 35 wt. % to 70 wt. % of the reactive diluent composition; and
(c) 0 wt. % to 20 wt. % of one or more further organic or inorganic additives.

The content of each component (a), (b) and (c) is based on the total amount of the curable resin composition. In a particular embodiment, the proportions of (a), (b) and (c) add up to 100 wt. %.

Suitable UP resins to be cured by the process of the present invention are so-called ortho-resins, iso-resins, iso-NPG resins, and dicyclopentadiene (DCPD) resins. UP resins as defined above are commonly known and commercially available.

For example, ortho-resins are based on phthtalic anhydride, maleic anhydride, or fumaric acid and glycols, such as ethylene glycol, diethylene glycol, triethylene glycol, 1,2-propylene glycol, 1,3-propylene glycol, dipropylene glycol, tripropylene glycol, neopentyl glycol or hydrogenated bis-phenol A. Commonly, the ones derived from 1,2-propylene glycol are used in combination with a reactive diluent. Iso-resins are usually prepared from isophthalic acid, maleic anhydride or fumaric acid, and the glycols. These resins may typically contain a higher level of reactive diluent than the ortho-resins. Bisphenol-A-fumarates are based on ethoxylated bisphenol-A and fumaric acid. Chlorendics are resins prepared from chlorine/bromine containing anhydrides or phenols in the preparation of UP-resins.

The curable resin composition may further comprise organic or inorganic additives, such as fillers, fibers, pigments, dispersants, inhibitors, co-agents, and promoters. Examples of fibers for the production of fiber-reinforced plastics are glass fibers, carbon fibers, aramid fibers, polyamide fibers, boron fibers, ceramic fibers, metal fibers, and natural fibers (e.g. jute, kenaf, industrial hemp, flax (linen), ramie, etc.) or any combination thereof. The fiber content depends on the fiber type, the production process used and the final application area. For example, in SMC formulations e.g. glass fiber contents are preferably up to 35 wt % in combination with a high filler content up to 40 wt %. The resin content in SMC applications is preferably between 10 wt % to 20 wt %. BMC formulations contain a higher filler content with preferably 60 wt % and a lower fiber content with preferably 15 wt %. In hand lay-up a fiber content of up to 60 wt % is preferred. In spray-up applications a moderate glass fiber content of 30-35 wt % is preferred mainly using chopped glass fibers. In filament winding and pultrusion 30-80 wt % glass rovings are used.

The curable resin composition may comprise at least one filler. Such filler may be selected from the group consisting of calcium carbonate, barium sulfate, quartz, talc, calcium sulfate, calcium silicate and/or kaolin. For flame retardancy, ATH (aluminum trihydroxide) or antimony oxides are added as fillers. Alternatively, or in addition thereto, the fiber-reinforced resin may also comprise at least one further additive selected from the group consisting of inhibitors, retarders, thixotropes (such as fumed silica), and/or UV absorbers, or mixtures thereof.

As pigments the curable resin composition may further comprise iron oxide, titanium dioxide, zinc sulfide, zinc oxide and/or organic or inorganic color pigments.

As promotors carboxylate salts of ammonium, alkali metals or alkaline earth methals and 1,3-diketones are suitable, e.g. acetyl acetone or diethyl acetoacetamide.

In addition to the above, the present invention provides a pre-accelerated formulation comprising the reactive curable resin composition described above, and at least one accelerator. Suitable accelerators are cobalt(II) salts or complexes e.g. cobalt halides, nitrates, sulfates, sulfonates, phosphates, phosphonates, oxides, or carboxylates. Suitable carboxylates are e.g. lactate, 2-ethyl hexanoate, acetate, propionate, butyrate, oxalate, laurate, oleate, linoleate, palmitate, stearate, acetyl acetonate, octanoate, nonanoate, heptanoate, neodecanoate, or naphthenate. The cobalt(II) salt or complex is preferably a cobalt alkyl carboxylate, such as cobalt(II) ethylhexanoate, cobalt(II) octanoate, or cobalt acetylacetonates or cyclopentadienyl-based complexes of cobalt. Cobalt(2-ethylhexanoate), cobalt (neodecanoate) or cobalt (naphthenate) are particularly preferred. Additionally, polymer-bound cobalt accelerators are suitable.

Alternatively, accelerators based on a copper(I) or copper (II) salt or complex are suitable. Suitable copper salts or complexes are e.g. copper halides (such as chlorides), nitrates, sulfates or alkyl carboxylates. Suitable carboxylates are e.g. lactate, 2-ethyl hexanoate, acetate, propionate, butyrate, oxalate, laurate, oleate, linoleate, palmitate, stearate, acetyl acetonate, octanoate, nonanoate, heptanoate, neodecanoate, or naphthenate. The copper(I) or copper (II) salt or complex is preferably an alkyl carboxylate. Copper(II) acetonate and Copper(II)-(2-ethylhexanoate) is particularly preferred.

Alternatively, accelerators based on iron salt or complex are suitable. Preferably, said iron(II) coordination compound is selected from the group consisting of iron(II) species ligated with mono- and polydentate N and/or O-donor ligands. Alternatively, the iron salt or complex present in the accelerator system (b) may also be selected from the group consisting of iron halides, carboxylates, 1,3-dioxo complexes and cyclopentadienyl-based iron complexes.

Curing is generally started by either adding an accelerator and an initiator to the curable resin composition according to the present invention, or by adding an initiator to the pre-accelerated formulation.

Accordingly, the present invention relates to a styrene-free method of curing unsaturated polyester resins, the method comprising
(a) providing a curable resin composition as described above, or, alternatively, a pre-accelerated formulation as described above,
(b) optionally adding at least one organic or inorganic additive as described above, and
(c) initiating the curing process by adding an initiator.

Peroxides suitable for curing the UP resins include inorganic peroxides and organic peroxides, such as conventionally used ketone peroxides, peroxyesters, diaryl peroxides, dialkyl peroxides, and peroxydicarbonates, but also peroxycarbonates, peroxyketals, hydroperoxides, diacyl peroxides, and hydrogen peroxide. Preferred peroxides are organic hydroperoxides, ketone peroxides, peroxyesters, and peroxycarbonates. Even more preferred are hydroperoxides and ketone peroxides. Preferred hydroperoxides include cumyl hydroperoxide, 1,1,3,3-tetramethylbutyl hydroperoxide, tert-butyl hydroperoxide, isopropylcumyl hydroperoxide, tert-amyl hydroperoxide, 2,5-dimethylhexyl-2,5-dihydroperoxide, pinane hydroperoxide, paramenthane hydroperoxide, terpene hydroperoxide and pinene hydroperoxide. Preferred ketone peroxides include methyl ethyl ketone peroxide, methyl isopropyl ketone peroxide, methyl isobutyl ketone peroxide, cyclohexanone peroxide, and acetylacetone peroxide. Mixtures of two or more peroxides can also be used; for instance, a combination of a hydroperoxide or ketone peroxide with a peroxyester.

A particularly preferred peroxide is methyl ethyl ketone peroxide. The skilled person will understand that these peroxides can be combined with conventional additives, for instance fillers, pigments, and phlegmatizers. Examples for phlegmatizers are hydrophilic esters and hydrocarbon solvents. The amount of peroxide to be used for curing the resin is preferably at least 0.1 per hundred resin (phr), more preferably at least 0.5 phr, and most preferably at least 1 phr. The amount of peroxide is preferably not more than 8 phr, more preferably not more than 5 phr, most preferably not more than 2 phr.

Advantageously, the initiator is an organic peroxide, preferably selected from the group consisting of methyl ethyl ketone peroxide (MEKP), benzoyl peroxide (BPO), cumene hydroperoxide (CuHP), or any combination thereof.

The curing process for the product of fibre-reinforced plastics can be carried out at any temperature from −15° C. up to 250° C., depending on the initiator system, the accelerator system, the compounds to adapt the curing rate, and the resin composition to be cured. Preferably, it is carried out at ambient temperatures commonly used in applications such as hand lay-up, spray-up, filament winding, resin transfer moulding, coating (e.g. gelcoat and standard coatings), button production, centrifugal casting, corrugated sheets or flat panels, relining systems, kitchen sinks via pouring compounds, etc. However, it can also be used in sheet molding compounds (SMC), bulk molding compounds (BMC), pultrusion techniques, and the like, for which temperatures up to 180° C., more preferably up to 150° C., most preferably up to 100° C., are used.

In general, fiber-reinforced resins (fiber-reinforced plastics—FRP) have the advantages of high relative strength, good surface condition of products, high corrosion resistance and high chemical resistance. With such advantages, these are used essentially as parts in housing materials, industrial materials, tanks, containers, ships, cars, trains, etc.

### EXAMPLES

### 1 Synthetic Procedures for Monomers

### 1.1 General Synthetic Procedures for Monomers

All reactions and product manipulations were carried out in common laboratory glassware under ambient conditions. Methyl (meth)acrylate, (meth)acrylic anhydride (MAAH), (meth)acryloyl chloride, 2-allyloxyethanol, 4-hydroxybutylvinylether, isoprenol, eugenol, 2-((allyloxy)methy)-2-ethylpropane-1,3-diol, 2,2-bis((allyloxy)methy)butan-1-ol, were obtained from commercial/industrial suppliers and used as received without further purification.

Eugenol methacrylate was synthesized following literature procedures, e.g. as described in Stanzione, J. F., Ill, Sadler, J. M., La Scala, J. J. and Wool, R. P. (2012), Lignin Model Compounds as Bio-Based Reactive Diluents for Liquid Molding Resins. ChemSusChem, 5:1291-1297.

Isoprenol methacrylate was synthesized following literature procedures, e.g. as described in Jacob M. Berlin, Katie Campbell, Tobias Ritter, Timothy W. Funk, Anatoly Chienov, and Robert H. Grubbs, Ruthenium-Catalyzed Ring-Closing Metathesis to Form Tetrasubstituted Olefins Org. Lett. 2007 9 (7), 1339-1342

4-(Vinyloxy)butyl methacrylate was synthesized following literature procedures, e.g. as described in
Farzad Seidi, a Victor Druet, a Nguyen Huynh, a Treethip Phakkeereea and Daniel Crespy Hemiaminal ether linkages provide a selective release of payloads from polymer conjugates Chem. Commun., 2018, 54, 13730-13733

2-(Allyloxy)ethyl methacrylate was synthesized following literature procedures, e.g. as described in
Xiao-Guang Sun, Craig L. Reeder, and John B. Kerr
Synthesis and Characterization of Network Type Single Ion Conductors
Macromolecules 2004, 37, 6, 2219-2227

2,2-bis((allyloxy)methy)butyl methacrylate and 2-((allyioxy)methyD)-2-ethylpropane-1,3-diyl dimethylacrylate were synthesized following literature procedures, e.g. as described in U.S. Pat. No. 4,640,940 A.

### 2 General Analytical Techniues Por Monomers

NMR spectra were recorded on Bruker Avance 300 or 400 spectrometers at 300 K unless otherwise noted and internally referenced to residual solvent resonances (¹H NMR: TH-d8: 1.72 ppm, C₆D₆: 7.16 ppm, toluene-d8 (tol-d8): 2.08 ppm; CDC Rt: 7.26 ppm. C{¹H} NMR: TH-d8: 25.31 ppm, C₆D₆: 128.06 ppm, CDCb3: 77.16 ppm). Chemical shifts 6 are given in ppm referring to external standards of tetramethylsilane (¹H, ¹³C(¹H)). ¹H and ¹³C NMR signals were assigned partially based on 2D NMR spectra (¹H, ¹H—COSY; ¹H, ¹³C—HSQC; ¹H, ¹³C-HMQC).

### 3 Polymerization and Composite Resins

### 3.1 Components Used

TABLE 1
Components used

| Component | |
|---|---|
| Standard unsaturated polyester resin (UPR 1) | Resin |
| (based on isophthalic acid and standard glycols, solid) | |
| VISIOMER ® GLYFOMA | Reactive diluent |
| VISIOMER ® BNMA | Reactive diluent |
| VISIOMER ® BDGMA | Reactive diluent |
| VISIOMER ® PEG200DMA | Reactive diluent |
| MMA (Roehm) | Reactive diluent |
| Styrene (Merck) | Reactive diluent |
| VISIOMER ® 1,4-BDDMA | Reactive diluent |
| VISIOMER ® EGDMA | Reactive diluent |
| 4-(Vinyloxy)butyl methacrylate | Compatibilizer |
| Isoprenol methacrylate | Compatibilizer |
| 2-(Allyloxy)ethyl methacrylate | Compatibilizer |
| Eugenol methacrylate | Compatibilizer |
| TMP Diallylether methacrylate = | Compatibilizer |
| 2,2-Bis((allyloxy)methyl)butyl methacrylate | |
| TMP Monoallylether dimethacrylate = | Compatibilizer |
| 2-((allyloxy)methyl)-2-ethylpropane-1,3-diyl | |
| dimethylacrylate | |
| Butanox M-50 (MEKP, Nouryon) | Initiator |
| Butanox P-50 (MIPKP, Nouryon) | Initiator |
| Co(II)-2-Ethylhexanoate, 65%-solution (11% Co | Cobalt-based |
| metal content, Sigma-Aldrich) | accelerator |
| Nouryact CF12 (1.5-1,7% Cu metal content), | Copper-based |
| Nouryon | accelerator |

wt % = weight percent
phr = parts per hundred resin

As resin is in this case the fully formulated resin defined including the reactive diluent.
MPa=Megapascal
HEMA=hydroxethyl methacrylate
BDGMA=butyl diglycol methacrylate
MMA=methyl methacrylate
BNMA=benzyl methacrylate
GLYFOMA=glycerol formal methacrylate
1,4-BDDMA=1,4-butanediol dimethacrylate
EGDMA=ethylene glycol dimethacrylate
MEKP=methyl ethyl ketone peroxide
MIPKP=methyl isopropyl ketone peroxide
TMP=1,1,1-trimethylol propane

### 3.2 Methods

### 3.2.1 Bulk Polymerization and Determination of the Polymerization Time

For the bulk polymerization stock solutions of the UPR resin and the various reactive diluents were prepared. The solid UPR resin was melted for 3 h at 100° C. The reactive diluent was added to the heated resin and homogenized on a roller bed for 12-24 h. The prepared stock solution was mixed with the different compatibilizers according to table 1-3. The accelerator was added, and the mixture was homogenized by stirring for 2 min followed by the addition of the initiator solution. The mixture was stirred again for 1.5 min and then transferred into a standard test tube (18×180 mm) and cured. The cured resins were post-cured for 8 h at 80° C. in a drying oven.

### 3.2.2 Mechanical Testing

The tensile testing was performed according to EN ISO 527-1. Approx. 110-115 g of resin formulation was used to cast films (calculated on 4 mm wet film thickness) The films were cured at RT over 24 h. All samples were post-cured for 8 h at 80° C. in the oven prior to the tensile testing.

TABLE 2
Curing behavior of UP Resin in combination with different reactive diluents

| Ex- | | | Reactive | | | | | | | | Appearance |
|---|---|---|---|---|---|---|---|---|---|---|---|
| ample | Resin | [wt %] | diluent | [wt %] | Compatibilizer | [wt %] | Initiator | [phr] | Accelerator | [phr] | cured resin |
| Ref 1 | UPR | 60 | HEMA | 40 | None | 0 | MEKP | 2 | Co(II)-2- | 0.22 | turbid |
| | 1 | | | | | | | | Ethylhexanoate | | |
| Ref 2 | UPR | 60 | BDGMA | 40 | None | 0 | MEKP | 2 | Co(II)-2- | 0.22 | turbid |
| | 1 | | | | | | | | Ethylhexanoate | | |
| Ref 3 | UPR | 60 | MMA | 40 | None | 0 | MEKP | 2 | Co(II)-2- | 0.22 | turbid |
| | 1 | | | | | | | | Ethylhexanoate | | |
| Ref 4 | UPR | 60 | Styrene | 40 | None | 0 | MEKP | 2 | Co(II)-2- | 0.22 | clear |
| | 1 | | | | | | | | Ethylhexanoate | | |
| Ref 5 | UPR | 60 | MMA | 40 | None | 0 | MIPKP | 2 | Nouryact | 2 | turbid |
| | 1 | | | | | | | | CF12r | | |
| Ref 6 | UPR | 60 | BNMA | 40 | None | 0 | MEKP | 2 | Cobalt | 0.22 | turbid |
| | 1 | | | | | | | | | | |
| 1 | UPR | 60 | MMA | 38 | 4-(Vinyloxy)butyl | 2 | MIPKP | 2 | Nouryact | 1 | clear |
| | 1 | | | | methacrylate | | | | CF12r | | |
| 2 | UPR | 60 | MMA | 35 | 4-(Vinyloxy)butyl | 5 | MIPKP | 2 | Nouryact | 1 | clear |
| | 1 | | | | methacrylate | | | | CF12r | | |
| 3 | UPR | 60 | MMA | 30 | 4-(Vinyloxy)butyl | 10 | MIPKP | 2 | Nouryact | 1 | clear |
| | 1 | | | | methacrylate | | | | CF12r | | |
| 4 | UPR | 60 | GLYFOMA | 38 | 4-(Vinyloxy)butyl | 2 | MEKP | 2 | Co(II)-2- | 0.22 | clear |
| | 1 | | | | methacrylate | | | | Ethylhexanoate | | |
| 5 | UPR | 60 | GLYFOMA | 35 | 4-(Vinyloxy)butyl | 5 | MEKP | 2 | Co(II)-2- | 0.22 | clear |
| | 1 | | | | methacrylate | | | | Ethylhexanoate | | |
| 6 | UPR | 60 | GLYFOMA | 30 | 4-(Vinyloxy)butyl | 10 | MEKP | 2 | Co(II)-2- | 0.22 | clear |
| | 1 | | | | methacrylate | | | | Ethylhexanoate | | |
| 7 | UPR | 60 | GLYFOMA + | 28 + 10 | 4-(Vinyloxy)butyl | 2 | MEKP | 2 | Co(II)-2- | 0.22 | clear |
| | 1 | | 1,4-BDDMA | | methacrylate | | | | Ethylhexanoate | | |
| 8 | UPR | 60 | GLYFOMA + | 28 + 10 | 4-(Vinyloxy)butyl | 2 | MEKP | 2 | Co(II)-2- | 0.22 | clear |
| | 1 | | 1,4-BDDMA | | methacrylate | | | | Ethylhexanoate | | |
| 9 | UPR | 60 | BNMA + | 28 + 10 | 4-(Vinyloxy)butyl | 2 | MEKP | 2 | Co(II)-2- | 0.22 | clear |
| | 1 | | 1,4-BDDMA | | methacrylate | | | | Ethylhexanoate | | |
| 10 | UPR | 60 | BNMA + | 28 + 10 | 4-(Vinyloxy)butyl | 2 | MEKP | 2 | Co(II)-2- | 0.22 | clear |
| | 1 | | 1,4-BDDMA | | methacrylate | | | | Ethylhexanoate | | |
| 11 | UPR | 60 | CHMA + | 28 + 10 | 4-(Vinyloxy)butyl | 2 | MEKP | 2 | Co(II)-2- | 0.22 | slightly |
| | 1 | | 1,4-BDDMA | | methacrylate | | | | Ethylhexanoate | | turbid |
| 12 | UPR | 60 | CHMA + | 28 + 10 | 4-(Vinyloxy)butyl | 2 | MEKP | 2 | Co(II)-2- | 0.22 | turbid |
| | 1 | | 1,4-BDDMA | | methacrylate | | | | Ethylhexanoate | | |

The reference examples show that without the addition of a compatibilizer turbid polymer resins are formed. Turbidity indicates phase separation and therefore an incompatibility of the reactive diluent with the UPR resin. Examples 1-6 show that the addition of a compatibilizer leads to the formation of clear polymers without any indication of phase separation. Example 7-12 show that also a mixture of reactive diluents can be employed. Example 11-12 show that the performance of the compatibilizer also depends on the right choice of reactive diluent. The performance of the compatibilizer is independent of the used curing system as shown using two different peroxides and two different accelerators.

[symbol]

TABLE 3
Curing behavior of UP Resin in combination with different methacrylate-based reactive diluents and different
compatibiliz [symbol] cured with 2 phr MEKP and 0.22 phr Co(II)-2-Ethylhexanoate

| | | | Reactive | | | | Appearance |
|---|---|---|---|---|---|---|---|
| Example | UPR resin | [wt %] | Diluent | [wt %] | Compatibilizer | [wt %] | cured Resin |
| 13 | UPR 1 | 55 | EGDMA | 43 | Isoprenol methacrylate | 2 | Clear |
| 14 | | | | | 4-(Vinyloxy)butyl methacrylate | 2 | Clear |
| 15 | | | | | 2-(Allyloxy)ethyl methacrylate | 2 | Clear |
| 16 | | | | | TMP-Diallylether methacrylate | 2 | Clear |
| 17 | | | | | TMP-Monoallylether dimethacrylate | 2 | Hazy |
| 18 | | | | | Eugenol methacrylate | 2 | Clear |
| 19 | UPR 1 | 55 | 1,4-BDDMA | 43 | Isoprenol methacrylate | 2 | Clear |
| 20 | | | | | 4-(Vinyloxy)butyl methacrylate | 2 | Clear |
| 21 | | | | | 2-(Allyloxy)ethyl methacrylate | 2 | Clear |
| 22 | | | | | TMP-Diallylether methacrylate | 2 | Clear |
| 23 | | | | | TMP-Monoallylether dimethacrylate | 2 | Hazy |
| 24 | | | | | Eugenol methacrylate | 2 | Clear |
| 25 | UPR1 | 60 | EGDMA | 38 | 4-(Vinyloxy)butyl methacrylate | 2 | Clear |

[symbol]

indicates data missing or illegible when filed

The addition of the tested compatibilizer compounds show, except for compatibilizer TMP-monoallylether dimethacrylate, clear polymer formation.

[symbol]

TABLE 4
Tensile Testing of UPR resin with benzyl methacrylate as reactive diluent in combination with and
without compatibilizer cu [symbol] with 2 phr MEKP and 0.22 phr Co(II)-2-Ethylhexanoate

| | | | | | | | | | Max. |
|---|---|---|---|---|---|---|---|---|---|
| | | | | | | | | Shear | Elongation |
| | | | Reactive | | | | E-Modulus | Strength | at break |
| Example | Resin | [wt %] | diluent | [wt %] | Compatibilizer | [wt %] | [MPa] | [MPa] | [%] |
| 26 | UPR 1 | 55 | BNMA | 45 | — | — | 3299 | 16.3 | 0.5 |
| 27 | UPR 1 | 55 | BNMA | 43 | 4-(Vinyloxy)butyl | 2 | 3404 | 59.3 | 2.2 |
| | | | | | methacrylate | | | | |
| 28 | UPR1 | 55 | Styrene | 45 | — | — | 3515 | 73.2 | 2.5 |

[symbol]

indicates data missing or illegible when filed

The mechanical testing shows that the styrene free UPR formulations using benzyl methacrylate as reactive diluents in combination with a compatibilizer result in comparable mechanical properties as the standard styrene-based UPR resin.

1. A reactive diluent composition, comprising:
a (meth)acrylic acid ester monomer and a compatibilizer;
wherein the (meth)acrylic acid ester monomer is at least one selected from the group consisting of methyl methacrylate, glycerol formal methacrylate, isopropylidene glycerol methacrylate, benzyl methacrylate, cyclohexyl methacrylate, isobornyl methacrylate, 1,4-butanediol dimethacrylate, 1,3-butanediol dimethacrylate, polethyleneglycol 200 dimethacrylate, ethylene glycol dimethacrylate, butyl diglycol methacrylate, and ethyltriglycol methacrylate,
wherein the compatibilizer comprises at least one (meth)acrylate moiety and at least one additional ethylenically unsaturated moiety and is at least one selected from the group consisting of vinylether (meth)acrylates, allylether (meth) acrylates, and alkenyl (meth)acrylates,
wherein the (meth)acrylic acid ester monomer and the compatibilizer are different chemical compounds, and
wherein a ratio of an amount of (meth)acrylic acid ester monomer to an amount of compatibilizer is between 1:1 and 70:1.

2. The reactive diluent composition according to claim 1,
wherein the at least one additional ethylenically unsaturated moiety is at least one vinylether (meth)acrylate are selected from the group consisting of monovinylether mono(meth)acrylates, monovinylether di(meth)acrylates, monovinylether tri(meth)acrylates, mono vinylether tetra(meth)acrylates, divinylether mono(meth)acrylates, divinylether di(meth)acrylates, divinylether tri(meth)acrylates, trivinylether mono(meth)acrylates, and trivinylether di(meth)acrylates.

3. The reactive diluent composition according to claim 1, wherein the at least one additional ethylenically unsaturated moiety is at least one allylether (meth) acrylate selected from the group consisting of monoallylether mono(meth)acrylates, monoallylether di(meth)acrylates, monoallylether tri(meth)acrylates, monoallylether tetra(meth)acrylates, diallylether mono(meth)acrylates, diallylether di(meth)acrylates, diallylether tri(meth)acrylates, triallylether mono(meth)acrylates, and triallylether di(meth)acrylates.

4. The reactive diluent composition according to claim 1,
wherein the at least one additional ethylenically unsaturated moiety is at least one alkenyl (meth)acrylate selected from the group consisting of mono, di, tri, and tetra(meth)acrylates containing one or more ethylenically unsaturated alkenyl (C═C) moiety being different from (meth)acrylate.

5. The reactive diluent composition according to claim 1, wherein the compatibilizer is at least one selected from the group consisting of 4-(vinyloxy)butyl methacrylate, 2-(allyloxy)ethyl methacrylate, isoprenol methacrylate, 2,2-bis((allyloxy)methyl)butyl methacrylate, 2-((allyloxy)methyl)-2-ethylpropane-1,3-diyl bis(2-methylacrylate), and eugenol methacrylate.

6. The reactive diluent composition according to claim 1,
wherein the compatibilizer is at least one selected from the group consisting of 4-(vinyloxy)butyl methacrylate, 2-(allyloxy)ethyl methacrylate, and isoprenol methacrylate.

7. (canceled)

8. (canceled)

9. The reactive diluent composition according to claim 1, wherein the (meth)acrylic acid ester monomer is benzyl methacrylate and the compatibilizer is at least one selected from the group consisting of is 4-(vinyloxy)butyl methacrylate, 2-(allyloxy)ethyl methacrylate, and isoprenol methacrylate.

10. (canceled)

11. The reactive diluent composition according to claim 1, wherein the ratio of the amount of (meth)acrylic acid ester monomer to the amount of compatibilizer is between 10:1 and 25:1.

12. The reactive diluent composition according to claim 1, further comprising a polymerization inhibitor.

13. The reactive diluent composition according to claim 12, wherein the polymerization inhibitor is at least one selected from the group consisting hydroquinones, hydroquinone ethers, phenothiazine, N,N′-(diphenyl)-p-phenylenediamine, 4-hydroxy-2,2,6,6-tetramethylpiperidin-1-oxyl, p-phenylene-diamine, methylene blue, and sterically hindered phenols.

14. The reactive diluent composition according to claim 1, comprising:
(a) 50 wt. % to 99 wt. % of the (meth)acrylic acid ester monomer:
(b) 1 wt. % to 50 wt. % of the reactive diluent composition; and
(c) 0 wt. % to 0.5 wt. % of the inhibitor.

15. A curable resin composition, comprising:
at least an unsaturated polyester resin and the reactive diluent composition according to claim 1.

16. The curable resin composition according to claim 15, further comprising at least one organic or inorganic additive.

17. A pre-accelerated formulation, comprising_:
the curable resin composition according to claim 15, and at least one accelerator.

18. A method of curing unsaturated polyester resins, the method comprising:
(a) providing a curable resin composition according to claim 15,
(b) optionally adding at least one organic or inorganic additive, and
(c) initiating the curing process by adding an initiator.

19. A method of curing unsaturated polyester resins, the method comprising:
(a) providing a pre-accelerated formulation according to claim 17,
(b) optionally adding at least one organic or inorganic additive, and
(c) initiating the curing process by adding an initiator.
